(19) United States
(12) Patent Application Publication
(10) Pub. No.: US 2026/0202043 A1
(43) Pub. Date: Jul. 16, 2026

(54) Wearable Traffic Safety Device

(71) Applicant: John Myers, Indianapolis, IN (US)

(72) Inventor: John Myers, Indianapolis, IN (US)

(21) Appl. No.: 19/021,448

(22) Filed: Jan. 15, 2025

(51) Int. Cl. F21V 21/088; F21L 4/08; F21V 23/04; F21W 111/10

(52) U.S. Cl. CPC F21V 21/0885; F21L 4/08; F21V 23/0414; F21W 2111/10

(57) ABSTRACT

A wearable traffic safety device for enhancing visibility of a user to oncoming traffic includes a housing and a clip that is coupled to the housing. The clip can be secured to clothing being worn by the user. A plurality of lights is each integrated into the housing to emit light outwardly from the housing thereby enhancing visibility of the user to oncoming traffic. A control knob is rotatably attached to the housing for actuating or de-actuating the plurality of lights.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to traffic safety devices and more particularly pertains to a new traffic safety device for enhancing visibility of a user to oncoming traffic. The device includes a housing and a clip coupled to the housing. The clip can be secured to clothing being worn by a user. The device includes a plurality of lights disposed on the housing and a control knob on the housing for actuating or de-actuating the lights.

### (2) Description of Related Art Including Information Disclosed Under 37 CFR 1.97 and 1.98

The prior art relates to traffic safety devices including a variety of vehicle warning light devices that are each mountable to a vehicle for emitting a visual alert to oncoming traffic to facilitate the oncoming traffic to avoid the vehicle. In no instance does the prior art disclose a wearable traffic safety device that includes a housing and a clip disposed on the housing which can be secured to clothing worn on a user and a plurality of lights on the housing for emitting light to alert oncoming traffic to the presence of the user.

### (h) BRIEF SUMMARY OF THE INVENTION

An embodiment of the disclosure meets the needs presented above by generally comprising a housing and a clip that is coupled to the housing. The clip can be secured to clothing being worn by a user. A plurality of lights is each integrated into the housing to emit light outwardly from the housing thereby enhancing visibility of the user to oncoming traffic. A control knob is rotatably attached to the housing for actuating or de-actuating the plurality of lights.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a wearable traffic safety device according to an embodiment of the disclosure.

FIG. 2 is a back perspective view of an embodiment of the disclosure.

FIG. 3 is a top phantom view of an embodiment of the disclosure.

FIG. 4 is a right side view of an embodiment of the disclosure.

FIG. 5 is a back phantom view of an embodiment of the disclosure.

FIG. 6 is a front perspective in-use view of an embodiment of the disclosure.

FIG. 7 is a perspective in-use view of an embodiment of the disclosure.

FIG. 8 is a side in-use view of an embodiment of the disclosure.

### (j) DETAILED DESCRIPTION OF THE INVENTION

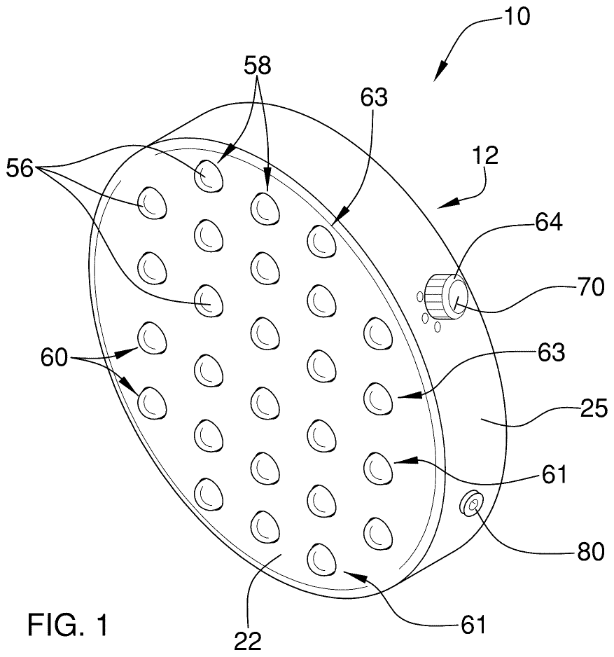

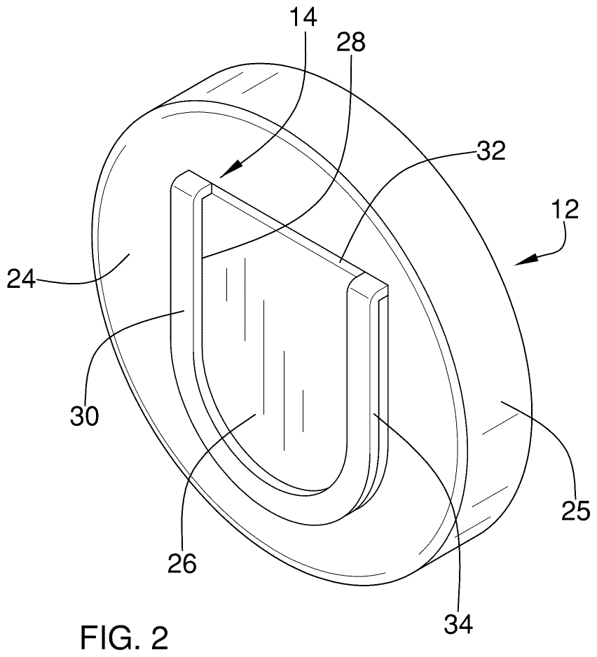

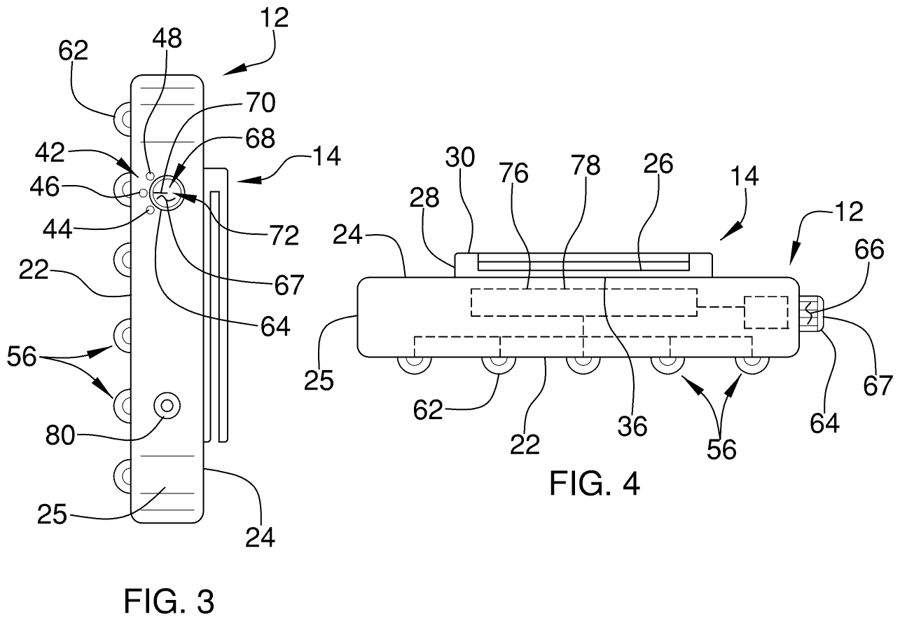

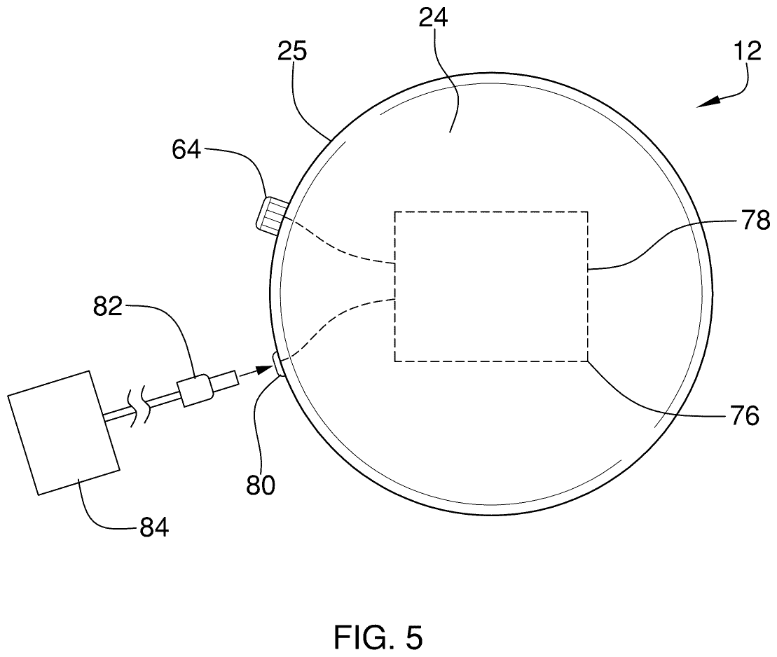

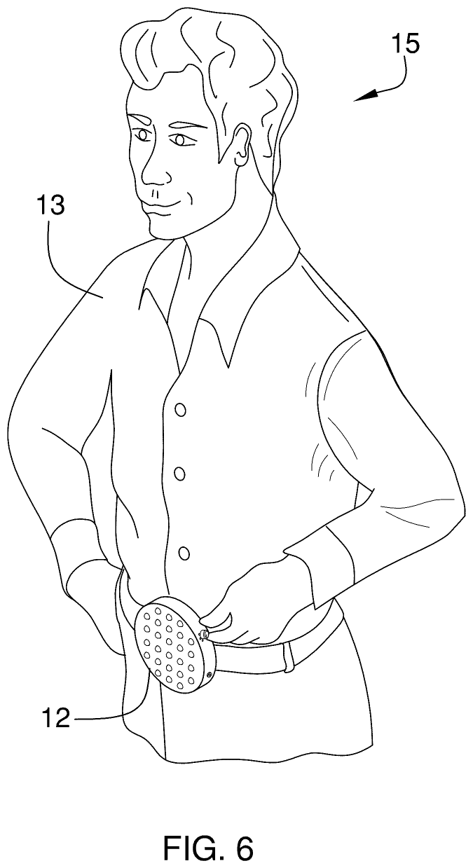

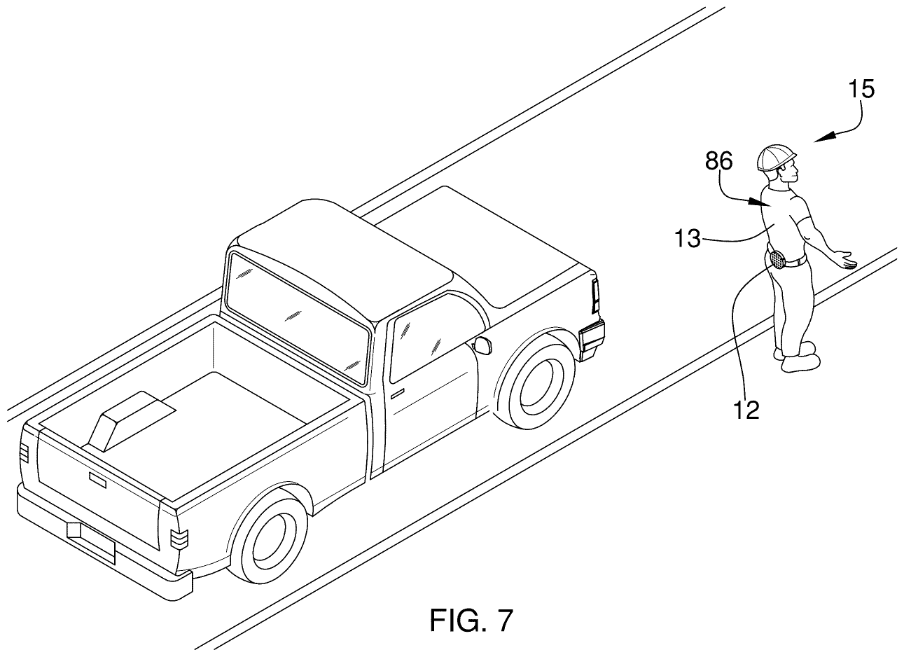

With reference now to the drawings, and in particular to FIGS. 1 through 8 thereof, a new safety device embodying the principles and concepts of an embodiment of the disclosure and generally designated by the reference numeral 10 will be described.

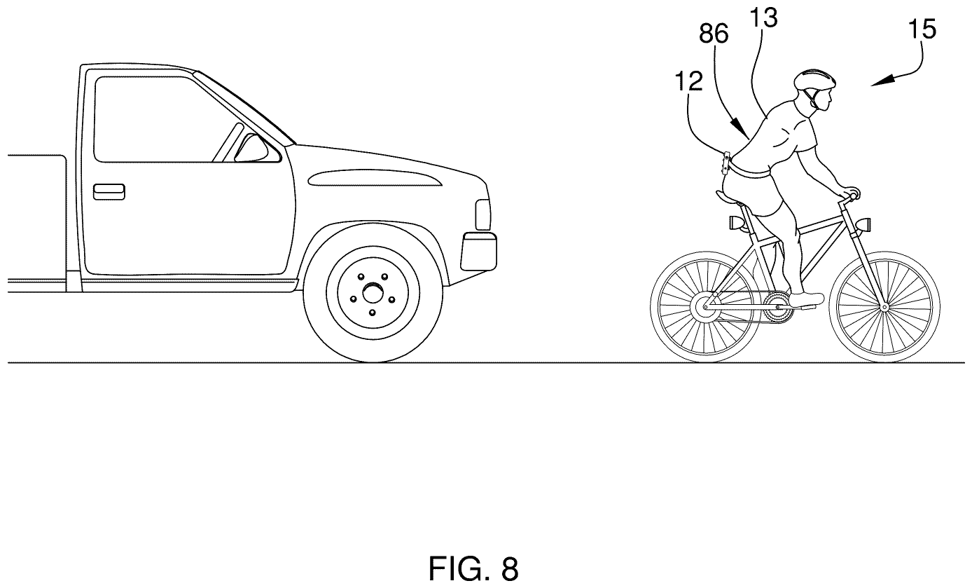

As best illustrated in FIGS. 1 through 8, the wearable traffic safety device 10 generally comprises a housing 12 and a clip 14 that is coupled to the housing 12. The clip 14 can be secured to clothing 13 being worn by a user 15. As is shown in FIG. 7, the user 15 may be a construction worker on a public roadway, for example, or other type of worker that is commonly exposed to oncoming traffic 21. As is shown in FIG. 8, the user 15 may be a bicyclist that is riding along a public roadway. The housing 12 has a front wall 22 and a back wall 24 and an outer wall 25 extending between the front wall 22 and the back wall 24.

The clip 14 has a rear wall 26 and an outer wall 28 extending away from the rear wall 26; the clip 14 has a lip 30 extending away from the outer wall 28. The lip 30 is distally positioned with respect to the rear wall 26 and the lip 30 lies on a plane that is oriented parallel to the rear wall 26. The rear wall 26 has an upper edge 32 and a lower edge 34; the lower edge 34 curves downwardly from the upper edge 32. Furthermore, the lower edge 34 curves about a major axis which is oriented parallel to the upper edge 32 and a minor axis which is oriented perpendicular to the upper edge 32 such that the rear wall 26 has a semi-ovoid shape.

The rear wall 26 has a front surface 36 and the front surface 36 is attached to the rear wall 26 of the housing. Furthermore, the clip 14 is oriented such that the minor axis of the lower edge 34 bisects the rear wall 26. The outer wall 28 extends along a full length of the lower edge 34 of the rear wall 26. Consequently, the outer wall 28 defines an opening 38 extending along the upper edge 32 of the rear wall 26 to insertably receive the clothing 13 worn by the user 15. The lip 30 extends along a full length of the outer wall 28 to retain the clothing 13 worn by the user 15 between the lip 30 and the rear wall 26. The clip 14 could potentially be attached to a coat button, for example, or a shirt button, for example, or any other structural element of the clothing 13 that can retain its shape in the clip 14.

Function indicia 42 are applied to the outer wall 32 of the housing 12. The function indicia 42 comprise an off dot 44 and an on dot 46 and a flash dot 48. Furthermore, the off dot 44 and the on dot 46 and the flash dot 48 is arranged to define an arc. A plurality of lights 56 is each attached to the housing 12 on an opposing side of the housing 12 with respect to the clip 14. The lights 56 emit light outwardly from the housing 12 when the lights 56 are turned on to make the user 15 visible to oncoming traffic 21. Furthermore, the oncoming traffic 21 has adequate reaction time to avoid striking the user 15 when the user 15 happens to be in the path of the oncoming traffic 21.

Each of the plurality of lights 56 is integrated into the front wall 22 of the housing 12 and the plurality of lights 56 is arranged into a plurality of columns 58 and rows 60 on the front wall 22. Each light 56 of the plurality of lights 56 includes a lens 62 which curves outwardly from the front wall 22 of the housing 12. Furthermore, each light 56 of the plurality of lights 56 may comprise a light emitting diode or other type of electronic light emitter which has a Society for Automotive Engineers (SAE) rating of J595 Class 2. The plurality of lights 56 includes a set of first lights 61 and a set of second lights 63. The set of first lights 61 emits light of a white color and the set of second lights 63 emits a light of yellow color.

A control knob 64 is rotatably attached to the housing 12 such that the control knob 64 can be manipulated by the user 15 and the control knob 64 is in electrical communication with each of the plurality of lights 56 for actuating or de-actuating the plurality of lights 56. The control knob 64 is disposed on the outer wall 32 of the housing 12. The control knob 64 is positionable in an off position having each of the plurality of lights 56 being turned off. Additionally, the control knob 64 is positionable in an on position having each of the plurality of lights 56 being turned on. Continuing, the control knob 64 is positionable in a flashing position having each of the plurality of lights 56 alternatively flashing on and off.

The control knob 64 has an outwardly facing surface 66 lying on a plane being oriented parallel to the outer wall 32 of the housing 12 and a perimeter surface 67. Mark indicia 68 are applied to the outwardly facing surface 66 of the control knob 64. The mark indicia 68 comprise a line 70 extending from a center 72 of the control knob 64 toward the perimeter surface 67 of the control knob 64. The line 70 is directed toward the off dot 44 when the control knob 64 is in the off position. Additionally, the line 70 is directed toward the on dot 46 when the control knob 64 is in the on position. Furthermore, the line 70 is directed toward the flash dot 48 when the control knob 64 is in the flashing position.

A power supply 76 is positioned within the housing 12 and the power supply 76 is in electrical communication with the control knob 64. The power supply 76 comprises a rechargeable battery 78 that is positioned within the housing 12 and the rechargeable battery 78 is in electrical communication with the control knob 64. The power supply 76 includes a charge port 80 that is recessed into the outer wall 32 of the housing 12 which can to insertably receive a charge cord 82 of a charger 84. The charge port 80 in electrical communication with the rechargeable battery 78 for charging the rechargeable battery 78.

In use, the clip 14 is secured to the clothing 13 to retain the housing 12 on the user 15. Typically the housing 12 will be positioned on the a back side 86 of the user 15 that the housing 12 is visible to oncoming traffic 21 that is approaching the user 15 from behind. The control knob 64 is manipulated into the on position to actuate the plurality of lights 56 to be continuously illuminated or the control knob 64 is manipulated into the flash position to actuate the lights 56 to alternatively flash on and off. The plurality of lights 56 make the user 15 visible to the oncoming traffic 21 during darkened hours or during daylight hours as well. Furthermore, the flashing of the lights 56 attracts the attention of the oncoming traffic 21 to ensure the oncoming traffic has adequate time to react to the user 15. The control knob 64 is manipulated into the off position to turn off the plurality of lights 56.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wearable traffic safety device which emits brightly colored light thereby facilitating a road worker to be visible to oncoming traffic thereby enhancing safety for the road worker, said device comprising:
a housing;
a clip being coupled to said housing wherein said clip is configured to be secured to a clothing being worn by a user;
a plurality of lights, each light of said plurality of lights being coupled to said housing, said plurality of lights being positioned on an opposing side of said housing with respect to said clip wherein each light of said plurality of lights is configured to emit light outwardly from said housing to make the user visible to oncoming traffic; and
a control knob being rotatably attached to said housing, said control knob being in communication with each light of said plurality of lights for actuating or de-actuating said plurality of lights.

2. The assembly according to claim 1, wherein:
said housing has a front wall and a back wall and an outer wall extending between said front wall and said back wall; and
said outer wall being continuously acuate about a center of said housing such that said housing has a disk shape.

3. The device according to claim 1, further comprising:
said clip having a rear wall and an outer wall extending away from said rear wall;
said clip having a lip extending away from said outer wall;
said lip being distally positioned with respect to said rear wall; and
said lip lying on a plane being oriented parallel to said rear wall.

4. The device according to claim 3, further comprising:
said rear wall having an upper edge and a lower edge;
said lower edge curving downwardly from said upper edge; and
said lower edge curving about a major axis being oriented parallel to said upper edge and a minor axis being oriented perpendicular to said upper edge such that said rear wall has a semi-ovoid shape.

5. The device according to claim 4, further comprising:
said rear wall having a front surface 36;
said front surface 36 being attached to said back wall of said housing; and
said clip being oriented such that said minor axis of said lower edge bisects said back wall.

6. The device according to claim 4, further comprising:
said outer wall extending along a full length of said lower edge of said rear wall; and
said outer wall defining an opening extending along said upper edge of said rear wall wherein said opening is configured to insertably receive the clothing worn by the user.

7. The device according to claim 3, further comprising said lip extending along a full length of said outer wall wherein said lip is configured to retain the clothing worn by the user between said lip and said rear wall.

8. The assembly according to claim 2, further comprising:
each of said plurality of lights being integrated into said front wall of said housing;
said plurality of lights being arranged into a plurality of columns and rows on said front wall; and
each light of said plurality of lights including a lens which curves outwardly from said front wall of said housing.

9. The assembly according to claim 2, wherein:
said control knob is disposed on said outer wall of said housing;
said control knob is in electrical communication with each light of said plurality of lights;
said control knob is positionable in an off position having each light of said plurality of lights being turned off;
said control knob is positionable in an on position having each light of said plurality of lights being turned on; and
said control knob is positionable in a flashing position having each light of said plurality of lights alternatively flashing on and off.

10. The assembly according to claim 2, wherein:
said control knob has an outwardly facing surface lying on a plane being oriented parallel to said outer wall of said housing;
said control knob having a perimeter surface;
said control knob has mark indicia being applied to said outwardly facing surface of said control knob; and
said mark indicia comprise a line extending from a center of said control knob toward said perimeter surface of said control knob.

11. The device according to claim 10, further comprising:
said housing having function indicia being applied to said outer wall of said housing;
said function indicia comprising an off dot and an on dot and a flash dot;
said off dot and said on dot and said flash dot being arranged to define an arc;
said line being directed toward said off dot when said control knob is in said off position;
said line being directed toward said on dot when said control knob is in said on position; and
said line being directed toward said flash dot when said control knob is in said flashing position.

12. The assembly according to claim 1, further comprising:
a power supply being positioned within said housing;
said power supply being electrically coupled to said control knob; and
said power supply comprising:
a rechargeable battery being positioned within said housing, said rechargeable battery being electrically coupled to said control knob; and
a charge port being recessed into said outer wall of said housing wherein said charge port is configured to insertably receive a charge cord of a charger, said charge port being electrically coupled to said rechargeable battery for charging said rechargeable battery.

13. A wearable traffic safety device which emits brightly colored light thereby facilitating a road worker to be visible to oncoming traffic thereby enhancing safety for the road worker, said device comprising:
a housing having a front wall and a back wall and an outer wall extending between said front wall and said back wall, said outer wall being continuously acuate about a center of said housing such that said housing has a disk shape;
a clip being attached into said housing wherein each of said clip is configured to be secured to clothing being worn by the user, said clip having a rear wall and an outer wall extending away from said rear wall, said clip having a lip extending away from said outer wall, said lip being distally positioned with respect to said rear wall, said lip lying on a plane being oriented parallel to said rear wall, said rear wall having an upper edge and a lower edge, said lower edge curving downwardly from said upper edge, said lower edge curving about a major axis being oriented parallel to said upper edge and a minor axis being oriented perpendicular to said upper edge such that said rear wall has a semi-ovoid shape, said rear wall having a front surface 36, said front surface 36 being attached to said back wall of said housing, said clip being oriented such that said minor axis of said lower edge bisects said back wall, said outer wall extending along a full length of said lower edge of said rear wall, said outer wall defining an opening extending along said upper edge of said rear wall wherein said opening is configured to insertably receive the clothing worn by the user, said lip extending along a full length of said outer wall wherein said lip is configured to retain the clothing worn by the user between said lip and said rear wall;
function indicia being applied to said outer wall of said housing, said function indicia comprising an off dot and an on dot and a flash dot, said off dot and said on dot and said flash dot being arranged to define an arc;
a plurality of lights, each light of said plurality of lights being integrated into said housing, said plurality of lights being positioned on an opposing side of said housing with respect to said clip wherein each of said plurality of lights is configured to emit light outwardly from said housing to make the user visible to oncoming traffic, each light of said plurality of lights being integrated into said front wall of said housing, said plurality of lights being arranged into a plurality of columns and rows on said front wall, each light of said plurality of lights including a lens which curves outwardly from said front wall of said housing;
a control knob being rotatably attached to said housing, said control knob being in electrical communication with each of said plurality of lights for actuating or de-actuating said plurality of lights, said control knob being disposed on said outer wall of said housing, said control knob being positionable in an off position having each of said plurality of lights being turned off, said control knob being positionable in an on position having each of said plurality of lights being turned on, said control knob being positionable in a flashing position having each of said plurality of lights alternatively flashing on and off, said control knob having an outwardly facing surface lying on a plane being oriented parallel to said outer wall of said housing, said control knob having a perimeter surface, said control knob having mark indicia being applied to said outwardly facing surface of said control knob, said mark indicia comprising a line extending from a center of said control knob toward said perimeter surface of said control knob, said line being directed toward said off dot when said control knob is in said off position, said line being directed toward said on dot when said control knob is in said on position, said line being directed toward said flash dot when said control knob is in said flashing position; and
a power supply being positioned within said housing, said power supply being in electrical communication with said control knob, said power supply comprising:
a rechargeable battery being positioned within said housing, said rechargeable battery being in electrical communication with said control knob; and
a charge port being recessed into said outer wall of said housing wherein said charge port is configured to insertably receive a charge cord of a charger, said charge port being in electrical communication with said rechargeable battery for charging said rechargeable battery.
